(19) United States
(12) Patent Application Publication
(10) Pub. No.: US 2012/0223972 A1
(43) Pub. Date: Sep. 6, 2012

(54) PROJECTING SYSTEM AND METHOD THEREOF

(75) Inventor: YING-HAO HSU, Tu-Cheng (TW)

(73) Assignee: HON HAI PRECISION INDUSTRY CO., LTD., Tu-Cheng (TW)

(21) Appl. No.: 13/096,974

(22) Filed: Apr. 28, 2011

(30) Foreign Application Priority Data
Mar. 2, 2011 (TW) 100106995

(51) Int. Cl. G06T 3/60

(52) U.S. Cl. 345/659

(57) ABSTRACT

A projecting method is provided. The method is implemented by a projecting system. The system includes a projector and an electronic device. The projector includes a first wireless communication unit and a projecting unit. The electronic device includes a second wireless communication unit and a storage unit. First transmits the orientation information indicating the orientation of the projector and the distance through the first wireless communication unit to the second wireless communication unit. Then, compares a currently received orientation of the projector with a previously received orientation of the projector to calculate a rotation angle of the projector. Next, determines a movement distance and a movement direction of a projected area projected with a portion of the to-be-projected image. Then, obtains the portion of the to-be-projected image according to the movement distance, movement direction, and magnification ratio. Last, controls the projecting unit to project the portion of the to-be-projected image.

### BACKGROUND

1. Technical Field

The present disclosure relates to projecting systems and methods and, particularly, to a wide angle projecting system and a method used by the projecting system.

2. Description of Related Art

Nowadays, projectors project an integrated image on the projector screen for the user to view. However, the user cannot feel as if they are at the place where the image has been taken.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a projecting system in accordance with an exemplary embodiment.

FIG. 2 is a schematic view of the projecting system of FIG. 1 projecting an image on a screen.

FIG. 3 is a flowchart of a projecting method in accordance with an exemplary embodiment.

### DETAILED DESCRIPTION

Embodiments of the present disclosure are now described in detail, with reference to the accompanying drawings.

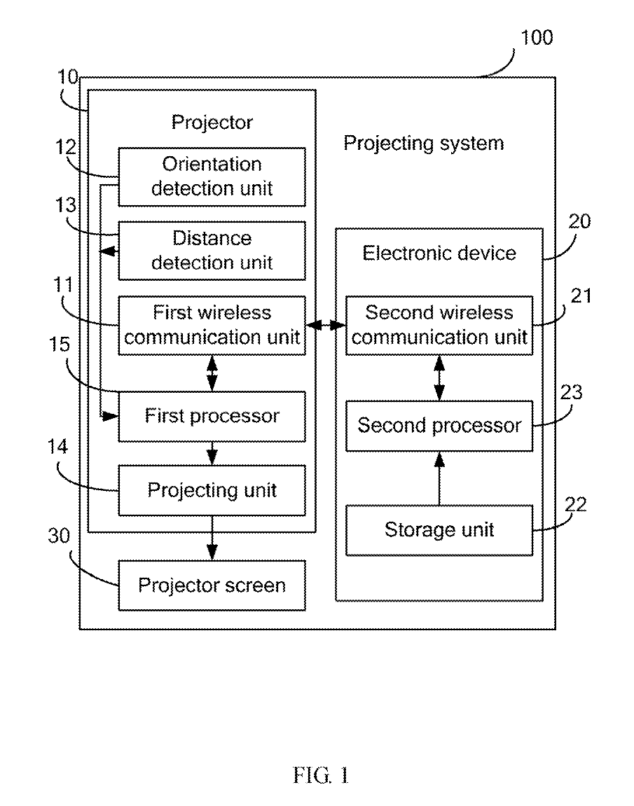

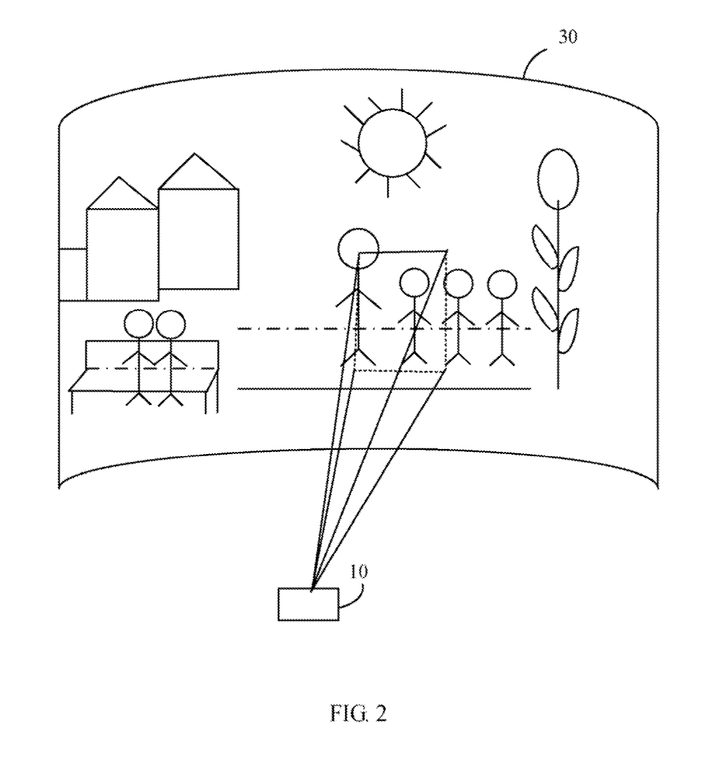

Referring to FIGS. 1-2, a block diagram of a projecting system 100 in accordance with an exemplary embodiment is shown. The projecting system 100 includes a portable projector 10 and an electronic device 20. The projector 10 is used to project images on a projector screen 30. In the embodiment, the projector 10 can project a portion of a panoramic image on the projector screen 30. The shape of the projector screen 30 as seen from a direction perpendicular to a widthwise direction is an arc. Thus, when the projector 10 rotates about the center of the projector screen 30, the distance between the projector 10 and the projector screen 30 is constant. When in use, the projector 10 can be attached to the head of a user, and move with the movements of the head. The projector 10 includes a first wireless communication unit 11, an orientation detection unit 12, a distance detection unit 13, a projecting unit 14, and a first processor 15. The electronic device 20 includes a second wireless communication unit 21, a storage unit 22, and a second processor 23.

The first wireless communication unit 11 is used to communicate with the second wireless communication unit 21. In the embodiment, the first wireless communication unit 11 and the second wireless communication unit 21 are WI-FI modules or BLUETOOTH modules.

When the projector 10 moves with the head of a user, the orientation of the projector 10 changes. The orientation detection unit 12 is used to detect the orientation of the projector 10. In the embodiment, the orientation detection unit 12 is a three-axis gyroscope.

The distance detection unit 13 is used to detect the distance between the projector 10 and the projector screen 30. In the embodiment, the distance detection unit 13 is an ultrasonic sensor or a laser distance measurer. The projecting unit 14 is used to project images on the projector screen 30. The storage unit 22 is used to store a number of images.

When projecting an image, the first processor 15 first determines whether the to-be-projected image is a panoramic image. If the to-be-projected image is not a panoramic image, the to-be-projected image is projected in a conventional manner.

When the projector 10 runs for the first time to project a panoramic image, an initializing process will be performed as follows. The first processor 15 first obtains the distance detected by the distance detection unit 13. The first processor 15 then calculates a projection area of the projector 10. The method of calculating the projection area is a conventional method, so the detailed description of the calculation method is omitted. The first processor 15 then transmits a request and the projection area through the first wireless communication unit 11 in response to an operation of the user. In the embodiment, because the distance between the projector 10 and the projector screen 30 is constant, the projection area projected by the projector 10 is constant.

The second processor 23 receives the request and the projection area of the projector 10 through the second wireless communication unit 21, obtains a portion of the to-be-projected panoramic image, and transmits the obtained portion of the to-be-projected panoramic image through the second wireless communication unit 21. In the embodiment, the obtained portion of the to-be-projected panoramic image is randomly selected from the to-be-projected panoramic image. The size of the portion of the to-be-projected panoramic image obtained by the second processor 23 is a preset value.

The first processor 15 receives the portion of the to-be-projected panoramic image through the first wireless communication unit 11, and projects the portion of the to-be-projected panoramic image on the projector screen 30 through the projecting unit 14. In the embodiment, the size of the projected area projected with the portion of the to-be-projected panoramic image on the projector screen 30 (hereinafter, projected area) is the same as that of the projection area.

In the embodiment, the second processor 23 further compares the size of the projected area and that of the portion of the to-be-projected panoramic image to calculate a magnification ratio for the obtained portion of the to-be-projected panoramic image.

After the second processor 23 calculates the magnification ratio, the first processor 15 transmits the orientation information indicating the orientation of the projector 10 and the distance between the projector 10 and the projector screen 30 through the first wireless communication unit 11. The second processor 23 receives the orientation information of the projector 10 and the distance, and compares the currently received orientation of the projector 10 with the previously received orientation of the projector 10 to calculate a rotation angle of the projector 10. The second processor 23 further calculates the movement distance and movement direction of the projected area according to the rotation angle. The second processor 23 then determines another portion of the to-be-projected panoramic image after the projector 10 moves with the head of the user according to the movement distance, the movement direction, and the magnification ratio. The second processor 23 obtains the determined another portion of the to-be-projected panoramic image, and transmits the determined another portion through the second wireless communication unit 21.

The first processor 15 receives the determined another portion of the to-be-projected panoramic image through the first wireless communication unit 11, and controls the projecting unit 14 to project the determined another portion of the to-be-projected panoramic image on the projector screen 30.

When the user turns his/her head, the projector 10 seems to rotate along with the neck of the user. The formula of the second processor 23 calculates the movement distance of the projected area is L=πrθ/180, where r represents the distance between the projector 10 and the projector screen 30, θ represents the rotation angle of the projector 10.

The initializing process is only performed when the projector 10 runs for the first time to project the panoramic image, and subsequent times the processors 15 and 23 perform the same as the first time.

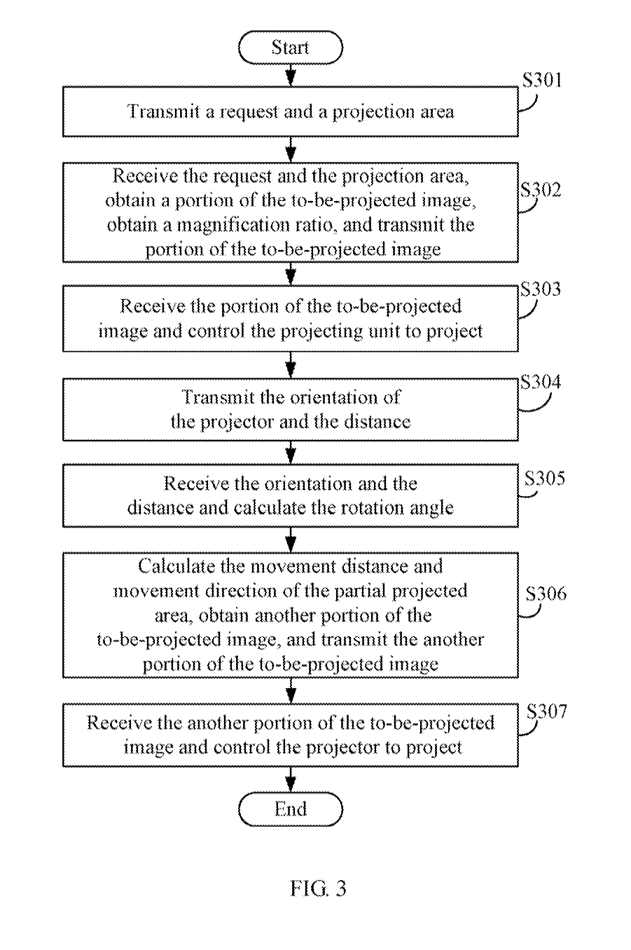

Referring to FIG. 3, a flowchart of a projecting method in accordance with an exemplary embodiment is shown.

In step S301, when the projector 10 runs for the first time to project a panoramic image, the first processor 15 transmits a request and a projection area through the first wireless communication unit 11 in response to the operation of the user.

In step S302, the second processor 23 receives the request and the projection area through the second wireless communication unit 21, obtains a portion of the to-be-projected panoramic image according to the request. Compares the size of the projected area with that of the portion of the to-be-projected panoramic image to obtain a magnification ratio of the image, and transmits the portion of the to-be-projected panoramic image through the second wireless communication unit 21.

In step S303, the first processor 15 receives the portion of the to-be-projected panoramic image through the first wireless communication unit 11, and controls the projecting unit 14 to project the portion of the to-be-projected panoramic image on the projector screen 30. In the embodiment, the size of the projected area is the same as that of the projection area.

In step S304, the first processor 15 transmits the orientation information indicating the orientation of the projector 10 detected by the orientation detection unit 12 and a distance detected by the distance detection unit 13 through the first wireless communication unit 11.

In step S305, the second processor 23 receives the orientation information and the distance through the second wireless communication unit 21, compares the currently received orientation of the projector 10 with the previously received orientation of the projector 10 to calculate the rotation angle of the projector 10.

In step S306, the second processor 23 calculates the movement distance and movement direction of the projected area according to the calculated rotation angle and the received distance. Obtains another portion of the to-be-projected panoramic image according to the movement distance, the movement direction, and the magnification ratio of the image, and transmits the another portion of the to-be-projected panoramic through the second wireless communication unit 21.

In step S307, the first processor 15 receives the another portion of the to-be-projected panoramic image through the first wireless communication unit 11, and controls the projecting unit 14 to project the another portion of the to-be-projected panoramic image on the projector screen 30.

When the projector 10 runs after the first time to project the panoramic image, the projecting method only executes steps S304-S307.

In that way, the eyes of the user will focus on a different place that will be projected a different corresponding part panoramic image. The user can feel as if they are at the place where the image has been taken.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A projecting system comprising:
a projector comprising:
a first wireless communication unit;
an orientation detection unit to detect an orientation of the projector;
a distance detection unit to detect a distance between the projector and a projector screen;
a projecting unit to project images on the projector screen; and
a first processor to transmit orientation information indicating the orientation of the projector and the distance through the first wireless communication unit; and
an electronic device comprising:
a second wireless communication unit to communicate with the first wireless communication unit;
a storage unit for storing a plurality of images; and
a second processor to receive the orientation information and the distance through the second wireless communication unit;
wherein the second processor compares a currently received orientation of the projector with a previously received orientation of the projector to calculate a rotation angle of the projector, and calculates a movement distance and a movement direction of a projected area projected with a portion of the to-be-projected image on the projector screen according to the rotation angle and the received distance;
wherein the second processor further determines the portion of the to-be-projected image after the projector rotates according to the movement distance, movement direction, and a magnification ratio of the obtained portion of the to-be-projected image, and transmits the portion through the second wireless communication unit;
wherein the first processor further receives the portion of the to-be-projected image through the first wireless communication unit, and controls the projecting unit to project the portion of the image on the projector screen.

2. The projecting system as described in claim 1, wherein the distance between the projector and the projector screen is a constant value.

3. The projecting system as described in claim 1, wherein the to-be-projected image is a panoramic image.

4. The projecting system as described in claim 1, wherein the first processor further transmits a request and projection area through the first wireless communication unit in response to user operates; the second processor receives the request and the projection area through the second wireless communication unit, obtains a portion of the to-be-projected image, compares the size of the projection area with the size of the projected area projected with the portion of the to-be-projected image on the projector screen to calculate the magnification ratio of the portion of the to-be-projected image, and transmits the portion to the first processor; the first processor receives the portion, and controls the projector to project the portion of the to-be-projected image on the projector screen; the size of the projected area projected by the portion of the to-be-projected image on the projector screen is the same as the projection area.

5. The projecting system as described in claim 1, wherein the orientation detection unit is a three-axis gyroscope.

6. The projecting system as described in claim 1, wherein the distance detection unit is an ultrasonic sensor.

7. The projecting system as described in claim 1, wherein the distance detection unit is a laser distance measurement.

8. A projecting method, the projecting method implemented by a projecting system, the projecting system comprising a projector and an electronic device; the projector comprising a first wireless communication unit, an orientation detection unit, a distance detection unit, and a projecting unit; the electronic device comprising a second wireless communication unit and a storage unit, the method comprising:
detecting the orientation of the projector through the orientation detection unit;
detecting the distance between the projector and a projector screen through the distance detection unit;
transmitting the orientation information indicating the orientation of the projector and the distance through the first wireless communication unit;
receiving the orientation information of the projector and the distance through the second wireless communication unit;
comparing a currently received orientation of the projector with a previously received orientation of the projector to calculate a rotation angle of the projector, and determining a movement distance and a movement direction of a projected area projected with a portion of the to-be-projected image on the projector screen according to the rotation angle and the received distance;
obtaining the portion of the to-be-projected image according to the movement distance, movement direction, and a magnification ratio of the image, and transmitting the portion of the to-be-projected image through the second wireless communication unit;
receiving the portion of the to-be-projected image through the first wireless communication unit, and controlling the projecting unit to project the portion of the to-be-projected image on the projector screen.

9. The projecting method as described in claim 8, wherein the distance between the projector and the projector screen is a constant value.

10. The projecting method as described in claim 8, wherein the to-be-projected image is a panoramic image.

11. The projecting method as described in claim 8, wherein the projecting method further comprising:
transmitting a request and the projection area of the projector through the first wireless communication unit in response to user operates;
receiving the request and the projection area of the projector through the second wireless communication unit;
obtaining a portion of the to-be-projected image, comparing the size of the projected area projected with the portion of the to-be-projected image on the projector screen with that of the portion of the to-be-projected image to calculate the magnification ratio of the portion of the to-be-projected image, and transmitting the portion of the to-be-projected image through the second wireless communication unit;
receiving the portion of the to-be-projected image through the first wireless communication unit, and projecting the portion of the to-be-projected image on the projector screen.

12. The projecting method as described in claim 11, wherein the size of the projected area projected on the portion with the to-be-projected on the projector screen is the same as that of the projection area.
